(19) United States
(12) Patent Application Publication
(10) Pub. No.: US 2018/0096411 A1
(43) Pub. Date: Apr. 5, 2018

(54) RECIPE MANAGEMENT SYSTEM

(71) Applicant: Wal-Mart Stores, Inc., Bentonville, AR (US)

(72) Inventors: Kevin Matthew Charles, Bentonville, AR (US); Michael Lawerance Payne, Centerton, AR (US); Jimmie R. Clark, Fayetteville, AR (US)

(21) Appl. No.: 15/724,289

(22) Filed: Oct. 4, 2017

Related U.S. Application Data
(60) Provisional application No. 62/404,454, filed on Oct. 5, 2016.

(51) Int. Cl. G06Q 30/06; G06Q 30/02

(52) U.S. Cl. CPC G06Q 30/0633; G06Q 30/0268; G06Q 30/0238; G06Q 30/0627

(57) ABSTRACT

A recipe management system is disclosed where participants can submit healthy recipes and their serving costs. If accepted, the recipes will then be posted via web, application, social media, and in-store advertising. The participants can include customers, vendors, etc. At checkout, the point of sale will make a web service call to compare ingredients being purchased with the active recipe offers. If all required ingredients are found, an appropriate discount will be applied. If most ingredients are in the cart, the customer will be notified via text, email, POS prompt, of other recipes close to completion, missing ingredients to receive the discount. The system includes an analytics system which monitors the ingredients and recipes sold, receives feedback from customers and social media to adjust the parameters of the system to improve its functioning, discounts and recipes provided.

### CROSS-REFERENCE TO RELATED APPLICATIONS

This application claims the benefit of U.S. Provisional Patent No. 62/404,454, filed Oct. 5, 2016, entitled “Recipe Management System,” the contents of which are incorporated by reference herein in their entirety.

### FIELD

Aspects of the present invention relate to a system for directing users toward an affordable and healthy meal, and more specifically to a system for directing users toward an affordable and healthy meal using cost discounts as incentive.

### BACKGROUND

Today with the high cost for healthy living, those with low incomes have difficulty providing healthy meals with quality products at a low cost for their families. One can find recipes which claim to be better for one's health than others, but these may vary greatly in their cost. These may be scattered in various locations and on various media.

The characterization of the term ‘healthy’ varies greatly from supplier to supplier and it is difficult to compare health benefits of one recipe to another if they have different suppliers.

Once he/she finds a recipe, the local store may not carry the items, also referred to as ingredients. Now he/she has the problem of trying to find the missing ingredients.

There is no central location to search to find healthy recipes within defined price categories that are located in a single store.

Another problem is that when a recipe becomes popular, the price tends to increase. It would be beneficial if there were a way to keep costs of ingredients of popular recipes steady.

Another concern is that some people have allergies to various ingredients. So it may be that once a person chooses a healthy recipe that is within a desired price range, and possibly buys the ingredients, he/she may find that they have an allergy to one of the ingredients. Some recipes indicate potential allergic reactions with certain ingredients, but it is not uniform.

Currently there is a need for a system and method that rates the health of recipes in a uniform manner, allows users to search healthy recipes based upon cost levels, ingredient availability and provides a means to keep costs of popular recipes steady.

### BRIEF SUMMARY

According to aspects of the present inventive concepts there is provided an apparatus and method as set forth in the appended claims. Other features of the inventive concepts will be apparent from the dependent claims, and the description which follows.

A system according to one embodiment of the current invention provides a portal for vendors and suppliers to submit healthy recipes and have them reviewed and publish those that have been accepted. Customer may also upload recipes to receive discounts. In an alternative embodiment, the system would ask the customer for allergies and provide alternative ingredients based on the customer's allergies. Users would be able to search for specific ingredients/products and recipes within a selected price range.

An embodiment of the current invention may be described as a system 1 for incentivizing a customer to purchase healthy recipes from a retail store, having a recipe database 160 having prestored recipes having ingredients and amounts, and their suppliers 3, a preprocessing system 100 adapted to receive, screen, and prestore selected recipes, a point of sale (POS) device 140 adapted to identify ingredients 9 being purchased, charge customers 5 for ingredients 9 purchased, suspend charging for items if the customer 5 requests time to adjust ingredients 9 being purchased, and apply discounts for full recipes purchased. Wherein the POS device 140 has an input/output (I/O) device 141 adapted to display messages to the customer 5, and to receive input from the customer 5, a coupon redemption device 150 coupled to the POS device 140, being prestored with discounts for a plurality of recipes in the recipe database 150, adapted to compare the ingredients 9 being purchased at the POS device 140 with the ingredients of recipes in the recipe database 160, determine the recipes having the most ingredients which match ingredients 9 being purchased, indicate to the customer 5 through the I/O device of these recipes and which ingredients are needed to complete the recipe, suspend purchasing if the customer 5 chooses to purchase the missing ingredients, and resume purchasing when the customer 5 returns to the POS device. The system also includes an analytics device coupled to the POS adapted to store the purchases of the POS device 140, analyze the purchases of the POS device 140 to determine the recipes that were purchased most, their ingredients and their suppliers 3. It also functions to receive customer feedback either directly, or through its advertising devices. This may include feedback from websites and more specifically, from social media websites 13.

Based upon the feedback received, the system may adjust how the validator device 120 accepts recipes to prestore. It may also adjust how the media device 130 selects recipes to advertise. It may also adjust how the management device 110 displays recipes found in search results, for example, listing those with the highest favorable ratings first.

These may lead to other actions such as requesting discounts from these suppliers 3 for these ingredients 9 based upon their sales.

An embodiment of the present invention may be described as a method for incentivizing a customer 5 to purchase healthy recipes from a retail store, by providing a recipe database 160 having prestored healthy recipes, their ingredients and amounts, and their suppliers 3, monitoring items selected by the customer 5 with a mobile device 190, identifying recipes with a coupon redemption device 150 which have ingredients similar to ingredients 9 selected by the customer. The system indicates ingredients that will complete one of the healthy recipes to the customer 5 at the point of sale device 140 during checkout. These will provide a group discount at the point of sale (POS) device 140 since all ingredients 9 of a healthy recipe are purchased together. The sales of ingredients for each supplier 3 of the healthy recipes are tracked by an analytics device 170, and the steps of this method may be modified according to feedback received by the analytics device. The functioning of elements of the method may be adjusted based upon the feedback received. Other actions may be performed such as requesting bulk discounts from suppliers based upon the estimated sales amount of ingredients sold.

Another embodiment of the current invention may be described as a system 1 for incentivizing a customer to purchase healthy recipes from a retail store having a recipe database 160 having prestored recipes having ingredients and amounts, and their suppliers 3, a preprocessing system 100 adapted to screen and prestore selected recipes, a mobile device 190 having a scanner 191 adapted to identify items being purchased, a coupon redemption device 150 coupled to the mobile device 190, and prestored with discounts for a plurality of recipes in the recipe database 160. The coupon redemption device is adapted to compare the items being purchased with the recipes in the recipe database 160; determine which recipes have the most ingredients 9 in common with ingredients being purchased; indicate to the customer 5 through the mobile device 190 the ingredients needed to complete the recipe; suspend purchasing if the customer 5 chooses to purchase the missing ingredients 9; and resume purchasing once the customer 5 has indicated that he/she would like to continue purchasing. The system for incentivizing further includes an analytics device 170 adapted to store the purchases of the POS device 140, analyze the purchases of the POS device 140 to determine the recipes that were purchased most, their ingredients and their suppliers 3. It also functions to receive customer feedback either directly, or through its advertising devices. This may include feedback from websites and more specifically, from social media websites 13.

Based upon the feedback received, the system may adjust how the validator device 120 accepts recipes to prestore. It may also adjust how the media device 130 selects recipes to advertise. It may also adjust how the management device 110 displays recipes found in search results.

### BRIEF DESCRIPTION OF SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale; emphasis instead being placed upon illustrating the principles of the concepts. For example, the dimensions of some of the elements in the figures may be exaggerated relative to other elements to help to improve understanding of various example embodiments. Also, common but well-understood elements that are useful or necessary in a commercially feasible embodiment are often not depicted in order to facilitate a less obstructed view of these various example embodiments.

FIG. 1 illustrates a block diagram showing the major components of a system for incentivizing customers to purchase ingredients for recipes according to one embodiment of the current invention.

FIG. 2 illustrates a flowchart illustrating the functioning of the system of FIG. 1.

FIG. 3 illustrates a block diagram showing the major components of a system for incentivizing customers to purchase ingredients for recipes according to another embodiment of the current invention.

### DETAILED DESCRIPTION

A system and method for incentivizing customers 5 to purchase ingredients for healthy recipes is disclosed. The system and method include four (4) phases:
1. Input/acceptance of recipes—Setup Phase;
2. Searching for healthy recipes within a selected cost range—Searching Phase;
3. Assisting customers in purchasing the correct ingredients—Purchasing Phase; and
4. Analyzing use of the system to improve it—Analytics Phase.

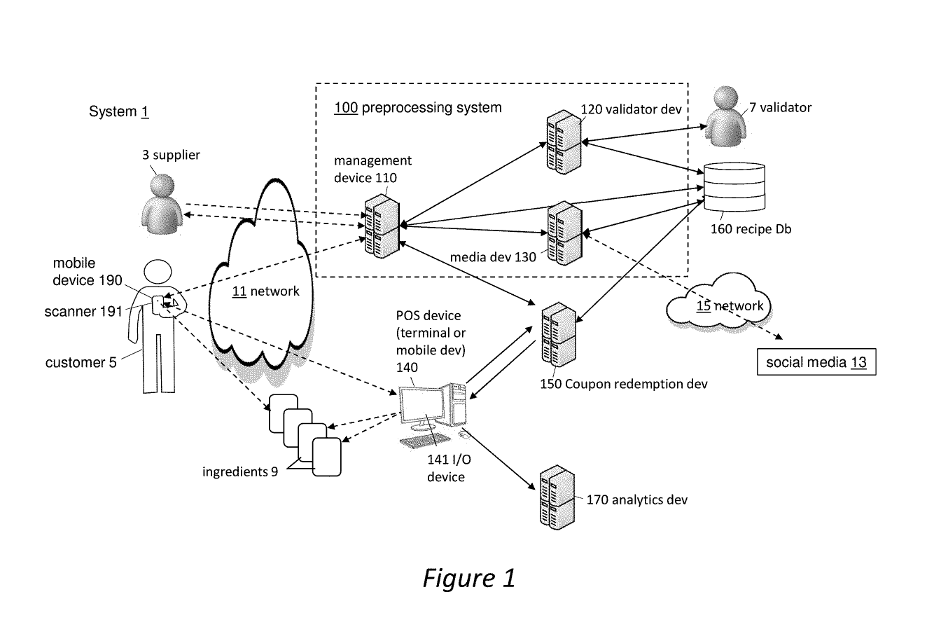

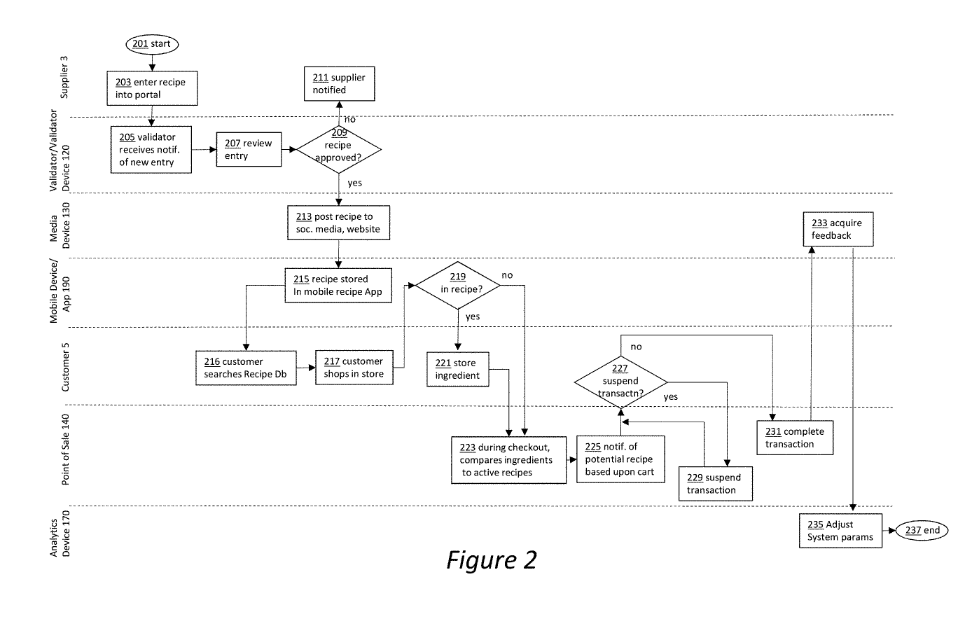

The structure and functioning of the recipe management system 1 will now be described in connection with FIGS. 1 and 2.

### 1. Setup Phase

The process begins in step 201 of FIG. 2. In step 203, a supplier 3 submits a recipe, its ingredients and a suggested discount to a management device 110 of a preprocessing system 100 of a recipe management system 1 for approval.

In step 205, the management device 110 passes the submission to a validator device 120 that may send a notification to a validator 7.

In step 207, the submitted entry (recipe) is reviewed by validator 7 running validator device 120. Validator device 120 has a number of preprogrammed rules, and routines to review the recipes submitted. Validators 7 research the submitted recipe/ingredients and either approve or reject the submission with the aid of the validator device 120.

The supplier 3 of the recipe is analyzed to make sure that it is a company in good standing with the retail store and that orders can be sent to the supplier 3.

Since these recipes are intended to be healthy recipes, validator device 120 analyzes the ingredients of the recipe and determines if there is more than a predetermined maximum amount of substances known to negatively affect the health of someone consuming that substance. The validator 7 has the ability to select one or more unhealthy substances suggested by the validator system 230 which he/she would like to minimize. The validator system 120 also suggests a maximum acceptable amount of each of these substances, per unit serving which may be overridden by validator 7.

For example, validator device 120 may be preprogrammed to check the amounts of saturated fats per serving in each of the recipes. It may then give a recommendation to validator 7 to reject a recipe based on too much saturated fat. Validator device 120 may use any number of preprogrammed unhealthy substances to review and compare against the predetermined maximum. In addition to fat and saturated fat content, the validator device 120 may limit the content of salt, artificial flavorings, artificial coloring, preservatives, and any other substances which have been known to have negative impacts upon the health of those consuming them.

Validator 7 and validator device 120 may also scan through ingredients of recipes submitted to determine if there are any ingredients which have been known to cause allergic reactions to those ingesting them. In one embodiment, validator 7 and validator device 120 may communicate through management device 110 to supplier 3 to request a replacement for the ingredients which have been known to cause allergic reactions.

In another alternative embodiment, notices are provided on those recipes having ingredients which are known to cause allergic reactions, for which there is no equivalent replacement ingredient.

Recipes may also be analyzed to determine if this specific retail store sells these items. For those items that this specific store does not sell, validator device 120 may send a message back through management device 110 to supplier 3 to ask for an alternative ingredient.

The retail store may create other rules for screening these recipes and have them implemented through validator 7 running validator device 120.

If the recipe is rejected in step 209 (“no”), validator device 120 notifies management device 110 which in turn notifies the supplier 3 in step 211 that the recipe has been rejected.

If the recipe is approved in step 209 (“yes”), validator device 120 stores the recipe in recipe database 160, and also provides a copy to media device 130.

Media system sends out notifications to the appropriate media channels to publish details about the recipe, ingredients and cost discounts. In step 213, media device 130 may publish the recipe on the retail store's website, and through a network, which also may be the Internet, to the social media websites 13.

In step 215, media device 130 may also add the approved recipes to an executable code application (“App”) that is executed by the mobile devices 190 of customer 5. The recipes may also be advertised on other advertising media.

In one embodiment, validator device 120 may run automatically through a set of preprogrammed rules to approve or reject recipes. Alternatively, it may analyze recipes and provide suggestions to the validator 7 relating to the submitted recipes.

Steps 201 through step 215 describe how recipes are submitted, vetted, approved and stored in the recipe database 160. These steps are intended to be repeated many times to result in many recipes being stored in recipe database 160.

### 2. Searching Phase

Once there are at least a few recipes stored in recipe database 160, customer 5 may remotely contact management device 110 through a network 11, such as the Internet, using his/her mobile device 190.

Management device 110 runs software which provides an interface to allow customer 5 to search recipe database 160. Recipe database 160 may be searched on any of its fields which may include type of food, type of ingredients, cuisine, fat contents, saturated fat content, salt content, sugar content, cost ranges, popularity, supplier, date of upload, and other relevant fields.

Once the results are displayed, customer 5 may reorder the results based on any number of factors, such as those listed above. For example, the search results may be listed in increasing order of saturated fat content.

If customer 5 does not select a parameter to reorder the search results, there will be default rules as to the order in which the search results should be displayed. This is important because users of search systems typically choose from entries on the first page of a search result list.

Therefore, the system can inadvertently guide customers, who do not have a preference, to certain types of recipes. This may be beneficial in guiding the customers to the proper search results.

For example, if the search results records are listed by default in the order of least saturated fats to most saturated fats, there is a better chance that the customer will choose a recipe which is healthier.

Similarly, the default search results may be arranged in an order which provides fresher foods. For example, records are listed in order with those having the most ‘in-season’ ingredients at the current time of year would direct customers to those recipes which utilize in-season fruits/vegetables. If it is May 20 and strawberry season is from May 6-June 6 in the local area in which the customer is shopping, those recipes utilizing strawberries that come back in the search results will be ranked higher and listed closer to the top of the listing than those not having any fruits or vegetables that are in season.

In another embodiment, when the user does not have a preference as to the order of the search results, the system can reorganize the search results such that recipes which use ingredients that are overstocked will be placed higher in the listing than those recipes that do not have ingredients that are overstocked in this store.

Conversely, those recipes which have ingredients which are about to be sold out, would be listed to the bottom of the listing, or listed in phantom, such as in light gray text. Also, recipes that were found that have ingredients that are out of stock, may be temporarily deleted from the listing. The management device 110 will be the active element which implements many of these rules.

### 3. 3. Purchasing Phase

In the purchasing phase, the recipe management system 1 assists the customer in purchasing the proper ingredients for recipes to obtain the cost discount. While shopping, customer 5 employs a scanner 191 on mobile device 190.

The customer's Mobile device 190 has software which allows scanner 191 to read optical patterns, such as barcodes, or QR codes of packaging of ingredients in the store.

In step 219, these barcodes or QR codes are converted into an identifier which is sent from mobile device 190 to management device 110 to the coupon redemption device 150.

Coupon redemption device 150 determines the identity of the item, and identifies which recipes use this ingredient. It may then return information through management device 110 to mobile device 190.

In step 219 it is determined if the ingredient is part of a recipe. If so, (“yes”), then the customer is notified and the ingredient is stored. In this way, customer 5 may immediately determine which, if any, of the ingredients that customer 5 intends to purchase, is part of any recipe which provides a discount.

If the ingredient is not part of a recipe, then step 221 is skipped.

In step 223, the customer 5 goes to the point of sale device (POS) 140 to pay for the ingredients. The POS device 140 checks to see if all of the ingredients of a recipe are being purchased. In step 225, if the customer 5 is purchasing most of the ingredients of a recipe, but not all of the ingredients, coupon redemption device 150 notifies POS device 140 to indicate such to the customer 5. POS device 140 may indicate this by either displaying a visual message, or providing an audible message to customer 5 indicating that the customer is close to fulfilling a complete recipe and indicates which ingredients are required to complete the recipe.

In step 227, the POS 140 asks the customer 5 if he/she would like to suspend the checkout transaction. If the customer 5 does not want to suspend the checkout transaction (‘no”), then the checkout transaction is completed in step 231.

If the customer 5 wants to suspend the checkout transaction (‘yes’), then it is suspended for a predetermined period of time to allow the customer 5 to go back into the store to get the missing ingredients and returns to the POS device 140.

After the predetermined period of time, processing returns back to step 227.

Once the coupon redemption device 150 identifies that the customer has purchased all ingredients for a recipe having a discount, the discounts are sent to the POS device 140 to reduce the charges to customer 5.

The discount for the group purchase of ingredients for a recipe is sent to the customer 5 to show the amount saved using the Recipe Management System 100. This may also be displayed on an input/output (“I/O”) device 141 of FIG. 1.

### 4. Analytics Phase

The POS device 140 sends the final transaction and coupon redemption data for customers 5 to the analytics device 170 for final storage

In step 233 the media device 130 acquires feedback on a plurality of the recipes stored in recipe database 160.

Analytics device 170 is directly connected to, and receives information on, ingredients purchased from the POS device 140 for a plurality of ingredients, recipes and suppliers.

In an alternative embodiment, analytics device 170 may be coupled to the POS device 140 through intermediate devices.

Media device 130 has access to a plurality of customers 5 and other users of the system that connect through network 11 to management device 130. Analytics 170 may receive feedback from customers 5 through surveys, requests etc.

### Sensing

Analytics device 1700 also communicates with media device 130. Media device 130 may also acquire feedback from social media sites regarding which recipes the social media users ‘Like’ or ‘Dislike’. This may be done for a plurality of recipes, suppliers, time periods and if the general locations of the social media users are known, then this information may be determined for different locations within the US, or for different countries. If the recipes are time stamped, and the Likes/Dislikes are time stamped, these results may be analyzed by time period. Therefore, trends may be determined. For example, recipes with the most Likes, a high ratio of Likes/Dislikes, or those trending to more Likes may be determined.

The Analytics device 170 may also receive information from the coupon redemption device 150 as to which completed recipes were purchased by the customers 5.

Similarly, those recipes having a large amount of sales may be advertised more than those with a small amount of sales.

The analytics device 170 can also determine which recipes have been advertised, but do not have significant sales.

### Actions

The media device 130 performs a function of advertising recipes and discounts. Therefore, Analytics device 170 may determine that there are a high number of Likes, a high ratio of Likes/Dislikes, or is trending upward for certain recipes. Analytics device 170 may then modify the media device 130 to publish these recipes more often than those having lower numbers of ‘Likes’, a lower ratio of Likes/Dislikes, or is trending downward.

Similarly, if there are few sales of a recipe and there has been little advertisement of the recipe, analytics device 170 may adjust media device 130 to advertise these recipes.

In step 235, management device 110 adjusts parameters of the Recipe Management System 1 to optimize its use, acquire more popular and healthy recipes, and reduce recipe costs.

Analytics device 170 may also work through management device 110 to ‘reduce’ the number of unpopular recipes, and store them in another location or recipes with a low ratio of likes/dislikes. This would reduce the number of recipes in the recipe database 160, but keep those which are better sellers or better liked.

Analytics device 170 may also work through validator device 110 to relax the requirements to accept more recipes that are similar to the most popular, the most liked recipes.

Similarly, it can tighten the requirements to accept fewer recipes that are similar to the less popular, and least liked recipes.

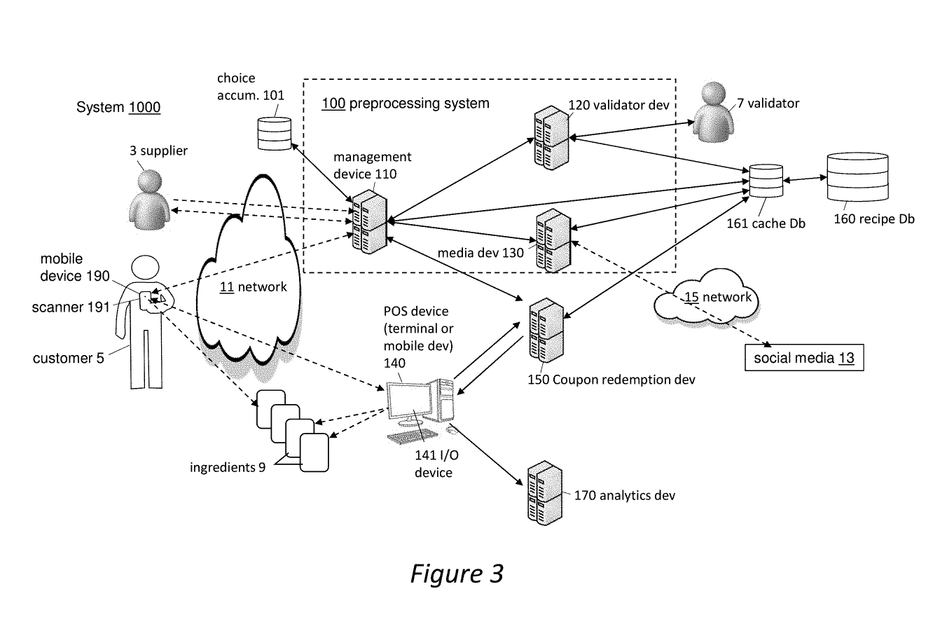

FIG. 3 illustrates a block diagram showing the major components of a system 1000 for incentivizing customers to purchase ingredients for recipes according to another embodiment of the current invention. All elements of FIG. 3 have the same function as those with the same numbers in FIG. 1. However, system 1000 has been modified to optimize searching and throughput by adding a cache database 161 which communicates with recipe database 160.

In the system 1000, if implemented on a large scale, recipe database 160 will be receiving a large number of search requests from the customers 5 through the management device 110 for various recipes. If the system 1000 is required to search through a large number of entries in the recipe database 160 for each request, it will be quite a large computational task.

However, if some assumptions could be made to reduce the computational burden for each search, this would greatly increase throughput of system 1000. For example, past history can be a predictor of future events. Management system 110 can keep records of the past search requests. A subset of recipes which were the most requested may be copied from the recipe database 160 and stored in a cache database 161. The cache database 161 will be searched first since it only has a small number of recipes, but those which were most often requested. If the recipe is found in the cache database 161, there will be a computation and time savings. If the recipe is not found in the cache database 161, then the full recipe database 160 is searched.

It would also be advantageous to sort the cache database 161 in order of the number of requests for each recipe. The most requested recipes should be at the beginning.

In a more dynamic approach, one can look at the recipes for which the requests are increasing the fastest. Again, these can be copied to the cache database 161 and sorted in order of actual requests, or increase in requests, etc.

Similarly, one can make the assumption that recipes which use ingredients that are on sale will be requested more often. Therefore, the recipes copied to the cache database 161 should include those which have ingredients which are on sale.

It may also be assumed that there will be a greater number of requests for recipes which include foods/recipes which are more highly advertised. Therefore, these recipes should be copied to the cache database 161, and possibly sorted.

It is also possible that several of the above assumptions may be used together and corresponding recipes copied to the cache database 161.

On a more individual level, management device 110 receives the recipe requests from the customer 5, and can monitor the items purchased by customer 5 at POS 140. Therefore, if there is a required login, the system can track the choices of customer 5. The customer 5 is monitored to accumulate choices over a long period of time to create choice factors that are stored in a choice accumulator 101.

For example, if customer 5 has not purchased any meats in a while, (s)he may be a vegetarian. Similarly, if customer 5 has also not purchased milk products over a period of time, (s)he may be a vegan. Therefore, one or more databases in cache database 161 may be a subset of recipe database 160 which only have vegetarian or vegan recipes.

The embodiments described above are examples. Any choice factors identified for a given customer 5 may be used to tailor a cache database for this type of customer.

In another alternative embodiment of the current invention, customers 5 will use mobile device 190 running an App to scan bar codes, QR codes, or other codes to identify the product in the shopping cart of customer 5. As described above, the mobile device 190 can indicate what items are needed to complete one or more recipes and receive a discount. At this point, mobile device 190 can suggest substitutes for recipe ingredients that are healthier, less expensive, on sale, etc.

Before suggesting substitutes, the choice factors for this customer 5 are sent from the choice accumulator 101 to the coupon redemption device 150. Any suggestions should be consistent with the customer's choice factors. For example, it will not suggest meat or meat products to a customer 5 with a vegetarian or vegan choice factors. The system 1000 will also try to suggest substitutes which rate high in the choice factors of customer 5.

Although a few examples have been shown and described, it will be appreciated by those skilled in the art that various changes and modifications might be made without departing from the scope of the invention, as defined in the appended claims.

What is claimed is:

1. A system for incentivizing a customer to purchase healthy recipes from a retail store, comprising:
a recipe database having prestored recipes having ingredients and amounts, and their suppliers;
a preprocessing system adapted to receive, screen, prestore, and advertise selected recipes;
a point of sale (POS) device adapted to identify ingredients being purchased, charge customers for ingredients purchased, suspend charging for ingredients if the customer requests time to adjust ingredients being purchased, and apply discounts for full recipes purchased;
wherein the POS device comprises:
an input/output (I/O) device adapted to display messages to the customer, and to receive input form the customer;
a coupon redemption device coupled to the POS device, being prestored with discounts for a plurality of recipes in the recipe database, adapted to:
compare the ingredients being purchased at the POS device with the ingredients of recipes in the recipe database;
determine the recipes having the most ingredients which match ingredients being purchased;
indicate to the customer through the I/O device, these recipes and which ingredients are needed to complete the recipe;
suspend purchasing if the customer chooses to purchase the missing ingredients; and
resume purchasing when the customer returns to the POS device;
an analytics device coupled to the POS and adapted to:
receive customer feedback;
based upon customer feedback, adjusting at least one of:
recipes selected to prestore;
recipes selected to advertise; and
an order of display of recipes in the search results.

2. The system of claim 1 wherein the preprocessing system comprises:
a management device adapted to interact with suppliers to receive recipes;
a validator device coupled to the management device adapted to approve received recipes that meet predetermined allergic and health standards; and
a media publishing device which publishes the approved recipes.

3. The system of claim 1 wherein
the management device keeps track of the previous searches requested by the customer and creates cumulative choice factors for the customer; and
the system further comprises:
a cache database device which receives the choice factors from the management device for the customer and extracts recipes consistent with the choice factors from the recipe database, which are searched before the recipe database to increase searching throughout.

4. The system of claim 1 wherein the coupon redemption system also applies discounts for coupons presented which match ingredients purchased.

5. The system of claim 2 wherein the validator device is adapted to:
verify that the supplier submitting the recipe is a valid supplier, verify that the discounts submitted by the supplier and the costs of the recipe are acceptable.

6. The system of claim 2 wherein the media publishing device publishes the approved recipes on at least one of a website, social media site, and an electronic billboard system.

7. The system of claim 2 wherein the validator device is adapted to analyze the ingredients for health and allergy considerations, and notify the supplier if the recipe is rejected on this basis.

8. A method for incentivizing a customer to purchase healthy recipes from a retail store, comprising the steps of:
providing a recipe database having prestored healthy recipes, ingredients and amounts, and their suppliers;
publishing selected healthy recipes and discounts on social media sites;
searching for recipes on the recipe database;
monitoring ingredients selected by the customer with a mobile device;
identifying recipes with a coupon redemption device which have ingredients similar to ingredients selected by the customer;
indicating to the customer by the point of sale device at checkout which ingredients will complete a healthy recipe and provide a group discount;
providing a group discount at the point of sale (POS) device when all ingredients of a healthy recipe are purchased together;
tracking the sales of ingredients for suppliers of the healthy recipes by an analytics device;
acquiring feedback on the recipes from the social media sites;
adjusting parameters of the method based upon the feedback results.

9. The method of claim 8, wherein the recipes selected to advertise are those receiving favorable feedback from the social media sites.

10. The method of claim 8, wherein the step of searching for recipes comprises the steps of:
searching for selected recipes in the recipe database;
displaying default search results in an order with those recipes having higher favorable feedback from the social media sites being listed higher in the search results.

11. The method of claim 8, wherein the step of searching for healthy recipes comprises the steps of:
searching for selected recipes in the recipe database to acquire search results;
checking the amount of ingredients of recipes in the search results that are overstocked;
displaying search results in an order with those recipes being the most overstocked being listed highest in the search results.

12. The method of claim 8, wherein the step of searching for healthy recipes comprises the steps of:
searching for selected recipes in the recipe database to acquire search results;
checking the amount of ingredients of recipes in the search results that are closest to the peak of their growing season;
displaying search results in an order with those recipes being the closes to their peak growing season being listed highest in the search results.

13. The method of claim 8, further comprising the steps of:
employing an analytics device to:
determine sales trends of ingredients to estimate sales of the ingredients at a future time for each supplier;
determine suppliers having sales above a predetermined amount; and
request bulk discounts from these suppliers based upon the estimated sales amount of ingredients sold.

14. The method of claim 8, wherein the step of providing a recipe database with prestored recipes comprises the steps of:
submitting a recipe and ingredients to a validator device;
verifying with the validator device that the ingredients of the submitted recipe are currently being sold by the retail store;
analyzing the recipe and ingredients to determine if they are associated with known allergy issues;
analyzing the recipe and ingredients to determine a cost of the recipe;
uploading those recipes in the recipe database for which the ingredients are currently being sold by the retail store, are determined to be healthy, and are within the predetermined costs per recipe.

15. The method of claim 8, further comprising the step of:
employing the validator device to attach warnings to those recipes which have ingredients which are associated with known allergy issues.

16. The method of claim 8 further comprising the step of:
analyzing the recipe and ingredients to verify that they cumulatively have less than a predetermined amount of substances known to adversely affect health.

17. A system for incentivizing a customer to purchase healthy recipes from a retail store, comprising:
a recipe database having prestored recipes having ingredients and amounts, and their suppliers;
a preprocessing system adapted to screen and prestore selected recipes;
a mobile device comprising:
a scanner adapted to identify ingredients being purchased;
a coupon redemption device coupled to the mobile device, and prestored with discounts for a plurality of recipes in the recipe database, adapted to:
compare the ingredients being purchased with the recipes in the recipe database;
determine which recipes have the most ingredients in common with ingredients being purchased,
indicate to the customer, through the mobile device, the ingredients needed to complete the recipe;
suspend purchasing if the customer chooses to purchase the missing ingredients; and
resume purchasing once the customer has indicated that he/she would like to continue purchasing; and
an analytics device coupled to the POS and adapted to:
receive customer feedback;
based upon customer feedback, adjusting at least at least one of:
recipes selected to prestore;
recipes selected to advertise; and
an order of display of recipes in the search results.

18. The system of claim 17 wherein the preprocessing system comprises:
a management device adapted to interact with suppliers to receive recipes;
a validator device coupled to the management device adapted to approve received recipes that meet predetermined allergic and health standards;
a media publishing device which publishes the approved recipes.

19. The system of claim 18 wherein the validator device analyzes the recipe ingredients to verify that they cumulatively have less than predetermined amounts of substances known to adversely affect health.

20. The system of claim 15 wherein the recipes in the recipe database include package size of at least one ingredient and the coupon redemption device only provides a discount when the ingredients purchased match a package size indicated in the recipe.
